(19) United States
(12) Patent Application Publication
(10) Pub. No.: US 2009/0136262 A1
(43) Pub. Date: May 28, 2009

(54) CHARGING DEVICE HAVING INTERLACED DISCHARGING TIPS

(76) Inventor: Gotoda Katsuhiko, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/946,813

(22) Filed: Nov. 28, 2007

(51) Int. Cl. G03G 15/02

(52) U.S. Cl. 399/173

(57) ABSTRACT

A charging device includes a plurality of electrode elements disposed in parallel to each other and a power supply for providing a voltage to the electrode elements. Each electrode element has a plurality of discharging tips arranged in a line, wherein the discharging tips of two adjacent electrode elements are positioned interlacedly. Therefore, when the charging device is implemented to charge a photoconductor of a printing device, the charging can be more uniform and the time needed to charge the photoconductor to a predetermined voltage level can be shortened. Moreover, the voltage applied to the electrode elements is not necessary to be as high as the voltage (4000-7000V) applied on conventional corona charging devices.

### BACKGROUND OF THE INVENTION

1. Field of the Invention

The present invention relates to a charging device, and more particularly, to a charging device implemented in an electrophotographic apparatus.

2. Description of the Prior Art

For an electrophotographic apparatus, such as a laser printer, charging a photoconductor drum (or an organic photoconductor belt) to a predetermined voltage level is a fundamental step in printing an image. Previous methods include charging the photoconductor drum by a roller or a brush that is charged to the predetermined voltage level and in contact with the photoconductor drum. However, the charging performance of the roller/brush is not stable. Temperature and humidity of surrounding environment will both influence the charging performance, while the distribution of electric charge on the photoconductor drum is highly related to the surface of the roller/brush and the contact between the roller/brush and the photoconductor drum. The contact charging techniques are therefore replaced by non-contact charging techniques with simpler structure.

Corona wire is one of the most popular non-contact charging techniques. In a corona charging device, an opening is formed in one side of a case and faces the photoconductor drum, and a metal wire is placed inside the case. When a high voltage (about 4000-7000V) is applied to the metal wire, the electric field intensity around the metal wire becomes so strong that the air inside the electric field is forced to dissociate, creating a large dissociation current. The dissociation current then charges the photoconductor drum to the predetermined voltage level.

Because the metal wire of the corona charging device is a thin wire, it can bend or break easily when subject to an external force. The usage lifetime of the metal wire is therefore not long. Moreover, any dust or carbon powder accidentally attached to the surface of the metal wire will influence the charging performance of the corona charging device since the dust and carbon powder will obstruct the electric field on that part of the metal wire. In this situation, the electric charge will not be uniformly distributed on the photoconductor drum, thereby declining the printing performance of the laser printer.

### SUMMARY OF THE INVENTION

Therefore, one objective of the present invention is to provide a charging device, whose charging is more uniform and the time needed to charge a photoconductor to a predetermined voltage level is shorter than conventional charging devices. Because the charging device of the present invention adopts point discharging, the voltage applied to the charging device does not need to be as high as the voltage applied to conventional charging devices.

According to an exemplary embodiment of the present invention, a charging device is disclosed. The charging device comprises a plurality of electrode elements, disposed in parallel to each other, each having a plurality of discharging tips arranged in a line, wherein the discharging tips of two adjacent electrode elements are positioned interlacedly; and a power supply, coupled to the electrode elements, for providing a voltage to the electrode elements.

According to another exemplary embodiment of the present invention, a charging device is disclosed. The charging device comprises an electrode element having a plurality of discharging tips arranged in an array, wherein the discharging tips of two adjacent rows of the array are positioned interlacedly; and a power supply, coupled to the electrode element, for providing a voltage to the electrode element.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a charging device according to an exemplary embodiment of the present invention.

FIG. 2 is a diagram showing the charging device of FIG. 1 implemented in an electrophotographic apparatus according to an exemplary embodiment of the present invention.

FIG. 3 shows a modified charging device according to the charging device of FIG. 1.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

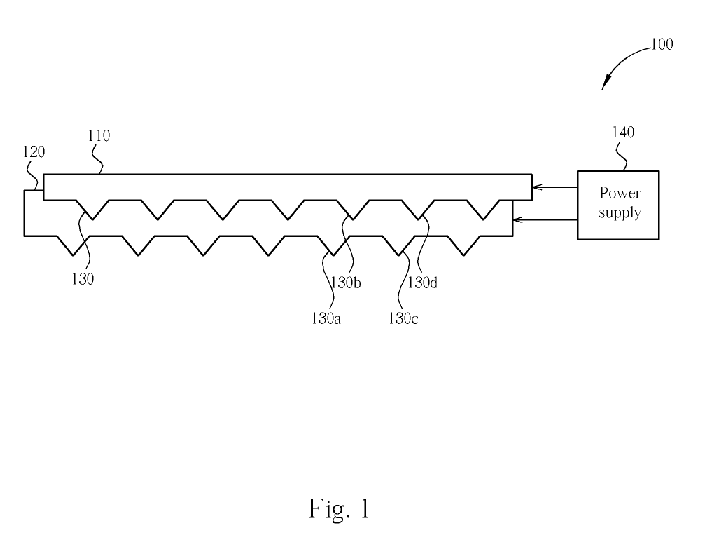

Please refer to FIG. 1, which is a diagram of a charging device 100 according to an exemplary embodiment of the present invention. The charging device 100 comprises a plurality of electrode elements 110 and 120, disposed in parallel to each other, each having a plurality of discharging tips 130 arranged in a line, and a power supply 140 coupled to the electrode elements 110 and 120, for providing a voltage to the electrode elements 110 and 120. The electrode elements 110 and 120 are arranged in a manner such that the discharging tips 130 of the electrode elements 110 and 120 are positioned interlacedly. That is, a discharging tip 130b of the electrode element 110 is positioned between a discharging tip 130a and a discharging tip 130c of the electrode element 120, and the discharging tip 130c of the electrode element 120 is positioned between the discharging tip 130b and a discharging tip 130d of the electrode element 110. For clarity, FIG. 1 only shows two electrode elements 110 and 120. However, the number of the electrode elements is not limited in the present invention. The charging device 100 can be equipped with more than two electrode elements, and in this situation, the electrode elements are arranged so that the discharging tips of two adjacent electrode elements can be positioned interlacedly. Moreover, the discharging tips 130 can be designed to point in different directions. The discharging tips 130 can extend downward as shown in FIG. 1, but also rightward, leftward, inward or outward. By pointing in different directions, the discharging tips 130 will benefit implementations of the charging device 100. For example, the charging device 100 can be used to charge an unsmooth or rough surface by appropriately bending the discharging tips 130.

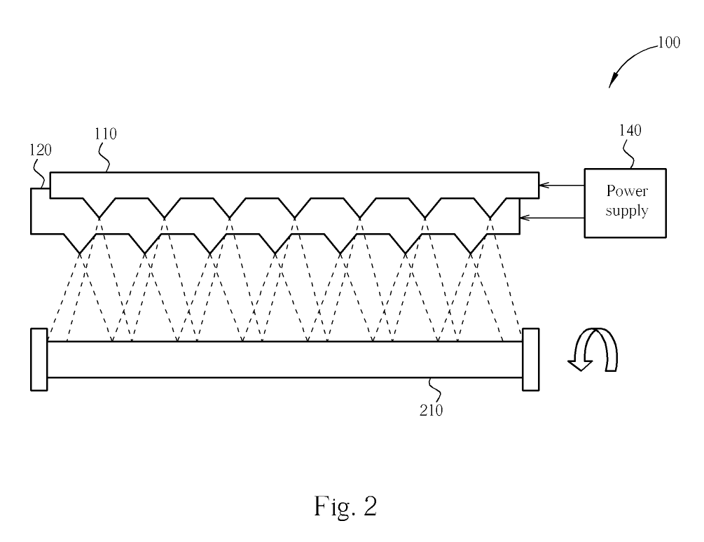

The electrode elements 110 and 120 can be electrode plates made of metal, tungsten or any other known material used for forming an electrode plate. When the power supply 140 provides a voltage to the electrode elements 110 and 120, electric charge gathers at the discharging tips 130, generating electric fields around the discharging tips 130. This forms the point discharging procedure. Please refer to FIG. 2, which is a diagram showing the charging device 100 of FIG. 1 implemented in an electrophotographic apparatus, such as a printing device. In this embodiment, the charging device 100 is a non-contact charging device, and the electrode elements 110 and 120 are utilized to charge a photoconductor 210 of the printing device. In this embodiment, the voltage provided by the power supply 140 is a positive voltage less than 5000V or a negative voltage larger than −5000V. Compared to the conventional corona charging device, the absolute voltage level provided by the power supply 140 is smaller because when the voltage provided to the charging device 100 and the conventional corona charging device are the same, discharging tips 130 gathering a large amount of electric charge can produce a larger electric field than the metal wire of the conventional corona charging device can. Furthermore, charging ranges of the electrode elements 110 and 120 on the photoconductor 210 are overlapped as indicated by the dotted lines in FIG. 2. Each part of the photoconductor 210 is charged by the electrode elements 110 and 120 simultaneously. In this way, the photoconductor 210 can be uniformly charged to a predetermined voltage level (e.g. the working voltage level of the photoconductor 210) in a short time. The required time for the charging device 100 to charge the photoconductor 210 to the predetermined voltage level corresponds to the density of the discharging tips 130. Since discharging tips 130 will not cause interference with each other, the number of the discharging tips 130 can be increased arbitrarily to further shorten charging time. However, the production cost will increase accordingly.

Please note that the implementation of the charging device 100 mentioned above is for illustrative purposes only and is not meant to be a limitation of the present invention. The charging device 100 can be utilized as a contacting charging device, or be implemented in other electrophotographic apparatuses.

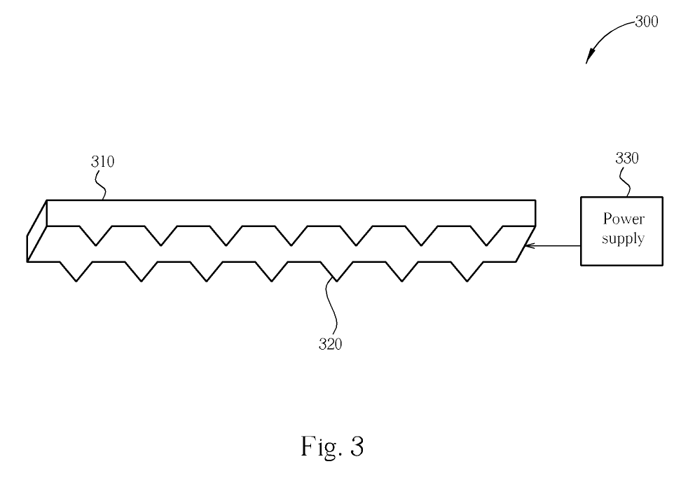

FIG. 3 shows a modified charging device 300 according to the charging device 100. The charging device 300 comprises an electrode element 310 having a plurality of discharging tips 320, and a power supply 330 coupled to the electrode element 310, for providing a voltage to the electrode element310. The major difference between the charging device 100 and the charging device 300 is that the discharging tips of the charging device 300 are formed on one electrode element 310. The discharging tips 320 of the electrode element 310 are arranged in an array, and the discharging tips 320 of two adjacent rows of the array are positioned interlacedly. (For clarity, FIG. 3 only shows two rows of the discharging tips 320.) Substantially, the charging device 300 has those advantages of the charging device 100 mentioned above, such as high charging uniformity and improved charging time; when the charging device 300 is implemented to charge a photoconductor of a printing device, it can achieve substantially the same efficiency and result as the charging device 100.

In the above embodiments, the electric fields are formed at the peaks of the discharging tips, which means that the charging procedure performed by the charging device 100 or 300 is through the peaks of the discharging tips. Therefore, external contaminants (such as dust or carbon powder) will not influence the charging performance of the charging device 100 and 300 as long as the peaks are not contaminated.

Those skilled in the art will readily observe that numerous modifications and alterations of the device and method may be made while retaining the teachings of the invention.

What is claimed is:

1. A charging device, comprising:
a plurality of electrode elements disposed in parallel to each other, each having a plurality of discharging tips arranged in a line, wherein the discharging tips of two adjacent electrode elements are positioned interlacedly; and
a power supply, coupled to the electrode elements, for providing a voltage to the electrode elements.

2. The charging device of claim 1, wherein the discharging tips point in different directions.

3. The charging device of claim 1, wherein the voltage provided by the power supply is a positive voltage less than 5000V.

4. The charging device of claim 1, wherein the voltage provided by the power supply is a negative voltage greater than −5000V.

5. The charging device of claim 1, implemented in an electrophotographic apparatus.

6. The charging device of claim 5, wherein the electrophotographic apparatus is a printing device, the charging device is a non-contact charging device, and the electrode elements are utilized to charge a photo conductor of the printing device.

7. A charging device, comprising:
an electrode element having a plurality of discharging tips arranged in an array, wherein the discharging tips of two adjacent rows of the array are positioned interlacedly; and
a power supply, coupled to the electrode element, for providing a voltage to the electrode element.

8. The charging device of claim 7, wherein the discharging tips point in different directions.

9. The charging device of claim 7, wherein the voltage provided by the power supply is a positive voltage less than 5000V.

10. The charging device of claim 7, wherein the voltage provided by the power supply is a negative voltage greater than −5000V.

11. The charging device of claim 7, implemented in an electrophotographic apparatus.

12. The charging device of claim 11, wherein the electrophotographic apparatus is a printing device, the charging device is a non-contact charging device, and the electrode elements are utilized to charge a photo conductor of the printing device.
